(19) United States
(12) Patent Application Publication
(10) Pub. No.: US 2018/0161743 A1
(43) Pub. Date: Jun. 14, 2018

(54) METHOD FOR OXYGENATE CONVERSION IN A FLUID CATALYTIC CRACKER

(71) Applicant: ExxonMobil Research and Engineering Company, Annandale, NJ (US)

(72) Inventors: Stephen J. McCARTHY, Center Valley, PA (US); Rustom M. BILLIMORIA, Hellertown, PA (US); Brandon J. O'NEILL, Lebanon, NJ (US); Ashish B. MHADESHWAR, Garnet Valley, PA (US); Amrit JALAN, Bridgewater, NJ (US)

(21) Appl. No.: 15/808,065

(22) Filed: Nov. 9, 2017

Related U.S. Application Data
(60) Provisional application No. 62/433,826, filed on Dec. 14, 2016.

(51) Int. Cl. B01J 8/28; C10G 51/06; B01J 8/18

(52) U.S. Cl. CPC B01J 8/28; C10G 51/06; B01J 2208/00761; B01J 2208/00752; B01J 8/1863

(57) ABSTRACT

Provided herein are dual riser fluid catalytic cracking processes for producing light olefins from an oxygenate feed, such as a methanol feed, in a conventional FCC unit. In certain aspects the processes comprise cracking a hydrocarbon feed in a first riser comprising a first catalyst under first riser conditions to form a first effluent enriched in olefins, light gasoil, gasoline, or a combination thereof; cracking a hydrocarbon oxygenate feed in a second riser comprising a second catalyst under second riser conditions to form a second effluent enriched in olefins; recovering the first and second catalyst from the first and second effluents in a common reactor; regenerating the recovered first and second catalyst in a regenerator using heat from the exothermic cracking of the hydrocarbon oxygenate feed; and recirculating the regenerated first and second catalyst to the first and second riser.

### CROSS-REFERENCE TO RELATED APPLICATIONS

This application claims the benefit of U.S. Provisional Application No. 62/433,826, filed on Dec. 14, 2016, the entire contents of which are incorporated herein by reference.

### FIELD

The invention is directed to methods and apparatus for converting oxygenate in a fluid catalytic cracking unit.

### BACKGROUND

Between 40% to 60% of the earth's proven natural gas reserves are either too small or too remote to be economically delivered to market. Such reserves are referred to as “stranded.”

Natural gas conversion to oxygenates, such as methanol, is a mature and widely-used technology. Oxygenates can then be converted to olefins, such as ethylene and propylene. Commercial plants for converting methanol to gasoline or light olefins have operated in New Zealand and China. However, methanol conversion processes currently require large capital investments and association with mega-fields of natural gas reserves.

Because of the economic challenges surrounding methanol to olefins (MTO) conversion, stranded gas has conventionally not been an economically feasible candidate. It would, however, be advantageous to be able to perform MTO using a pre-existing piece of refinery equipment. The fluid catalytic cracking (FCC) unit present in many refineries operates under conditions similar to those required for MTO. The FCC unit is typically used to upgrade vacuum gasoil and heavy gasoil to olefins, light gasoil, and gasoline. Pan et al. contemplated feeding methanol into an FCC unit to produce olefins at four different points—the bottom of the riser before feeding the gasoil, co-feeding gasoil and methanol, feeding methanol at the top of the riser, and feeding methanol in the stripper and disengage zone. See Shuyu Pan et al., Feeding Methanol in an FCC Unit, 26 PETRO. SCI. & TECH. 170 (2008).

The issue with this approach is that olefin production is not maximized. By using a single riser, olefin production is limited by reaction conditions that are optimal for the conventional FCC reaction process. It is proposed herein to use a dedicated MTO riser within the FCC unit in addition to a riser for gasoil. The dual riser configuration will allow to optimize olefin production from the oxygenate feed in the MTO riser.

### SUMMARY

Provided herein are dual riser fluid catalytic cracking processes for producing light olefins from an oxygenate feed, such as a methanol feed, in a conventional FCC unit. In certain aspects the processes comprise cracking a hydrocarbon feed in a first riser comprising a first catalyst under first riser conditions to form a first effluent enriched in olefins, light gasoil, gasoline, or a combination thereof cracking a hydrocarbon oxygenate feed in a second riser comprising a second catalyst under second riser conditions to form a second effluent enriched in olefins; recovering the first and second catalyst from the first and second effluents in a common reactor; regenerating the recovered first and second catalyst in a regenerator using heat from the exothermic cracking of the hydrocarbon oxygenate feed; and recirculating the regenerated first and second catalyst to the first and second riser.

In one aspect, the second riser conditions include a catalyst activity, α, of about 5 to 130, e.g. about 10. In another aspect, the second riser conditions include a weight hourly space velocity (WHSV) of about 1-150 h⁻¹, e.g. about 10-100 h⁻¹ or about 20-85 h⁻¹. In yet another aspect, the second riser conditions include a temperature of about 538-760° C. The second riser conditions may also include a combination of the catalyst activity, WHSV, and temperatures state above.

In certain aspects, the first and second catalysts can be the same or different. When the first catalyst and the second catalyst are different, the first catalyst can be a USY catalyst and the second catalyst is ZSM-5, ZSM-11, ZSM-48, or a combination thereof. In another aspect, the first catalyst and the second catalysts are different densities such that they form a layer of first catalyst and a layer of second catalyst in the regenerator; wherein recirculating the regenerated first and second catalyst to the first and second riser further comprises positioning a first riser standpipe to recirculate regenerated first catalyst to the first riser from the layer of first catalyst; and positioning a second riser standpipe to recirculate a regenerated second catalyst to the second riser from the layer of second catalyst. In yet another aspect when the first and second catalysts are different, the first and second catalysts are kept separate from one another by a baffle within the common reactor.

### BRIEF DESCRIPTION OF THE DRAWINGS

FIG. 1 schematically illustrates a dual riser FCC process and apparatus according to embodiments of the invention.

FIG. 2 depicts model predictions of methanol to olefin conversion based on different introduction points within a FCC unit.

### DETAILED DESCRIPTION

As used herein references to a “reactor,” “reaction vessel,” and the like shall be understood to include both distinct reactors as well as reaction zones within a single reactor apparatus. In other words and as is common, a single reactor may have multiple reaction zones. Where the description refers to a first and second reactor, the person of ordinary skill in the art will readily recognize such reference includes a single reactor having first and second reaction zones. Likewise, a first reactor effluent and a second reactor effluent will be recognized to include the effluent from the first reaction zone and the second reaction zone of a single reactor, respectively.

As used herein the phrase “at least a portion of” means >0 to 100 wt % of the process stream or composition to which the phrase refers. The phrase “at least a portion of” refers to an amount ≤ about 1 wt %, ≤ about 2 wt %, ≤ about 5 wt %, ≤ about 10 wt %, ≤ about 20 wt %, ≤ about 25 wt %, ≤ about 30 wt %, ≤ about 40 wt %, ≤ about 50 wt %, ≤ about 60 wt %, ≤ about 70 wt %, ≤ about 75 wt %, ≤ about 80 wt %, ≤ about 90 wt %, ≤ about 95 wt %, ≤ about 98 wt %, ≤ about 99 wt %, or ≤ about 100 wt %. Additionally or alternatively, the phrase “at least a portion of” refers to an amount ≥ about 1 wt %, ≥ about 2 wt %, > about 5 wt %, > about 10 wt %, >about 20 wt %, >about 25 wt %, ≥about 30 wt %, ≥about 40 wt %, ≥ about 50 wt %, ≥ about 60 wt %, ≥ about 70 wt %, ≥ about 75 wt %, ≥ about 80 wt %, ≥ about 90 wt %, ≥ about 95 wt %, ≥ about 98 wt %, or ≥ about 99 wt %. Ranges expressly disclosed include all combinations of any of the above-enumerated values; e.g., ˜10 wt % to ˜100 wt %, ˜10 wt % to ˜98 wt %, ˜2 wt % to ˜10 wt %, ˜40 wt to ˜60 wt %, etc.

As used herein the term “oxygenate,” “oxygenate composition,” and the like refer to oxygen-containing compounds and mixtures of oxygen-containing compounds that have 1 to about 50 carbon atoms, 1 to about 20 carbon atoms, 1 to about 10 carbon atoms, or 1 to 4 carbon atoms. Exemplary oxygenates include alcohols, ethers, carbonyl compounds, e.g., aldehydes, ketones and carboxylic acids, and mixtures thereof. Particular oxygenates methanol, ethanol, dimethyl ether, diethyl ether, methylethyl ether, di-isopropyl ether, dimethyl carbonate, dimethyl ketone, formaldehyde, and acetic acid.

In any aspect, the oxygenate comprises one or more alcohols, preferably alcohols having 1 to about 20 carbon atoms, 1 to about 10 carbon atoms, or 1 to 4 carbon atoms. The alcohols useful as first mixtures may be linear or branched, substituted or unsubstituted aliphatic alcohols and their unsaturated counterparts. Non-limiting examples of such alcohols include methanol, ethanol, propanols (e.g., n-propanol, isopropanol), butanols (e.g., n-butanol, sec-butanol, tert-butyl alcohol), pentanols, hexanols, etc., and mixtures thereof. In any aspect described herein, the first mixture may be one or more of methanol, and/or ethanol, particularly methanol. In any aspect, the first mixture may be methanol and dimethyl ether.

The oxygenate, particularly where the oxygenate comprises an alcohol (e.g., methanol), may optionally be subjected to dehydration, e.g., catalytic dehydration over e.g., γ-alumina. Further optionally, at least a portion of any methanol and/or water remaining in the first mixture after catalytic dehydration may be separated from the first mixture. If desired, such catalytic dehydration may be used to reduce the water content of reactor effluent before it enters a subsequent reactor or reaction zone, e.g., second and/or third reactors as discussed below.

Reference will now be made to various aspects and embodiments of the disclosed subject matter in view of the definitions above. Reference to the systems will be made in conjunction with, and understood from, the method disclosed herein.

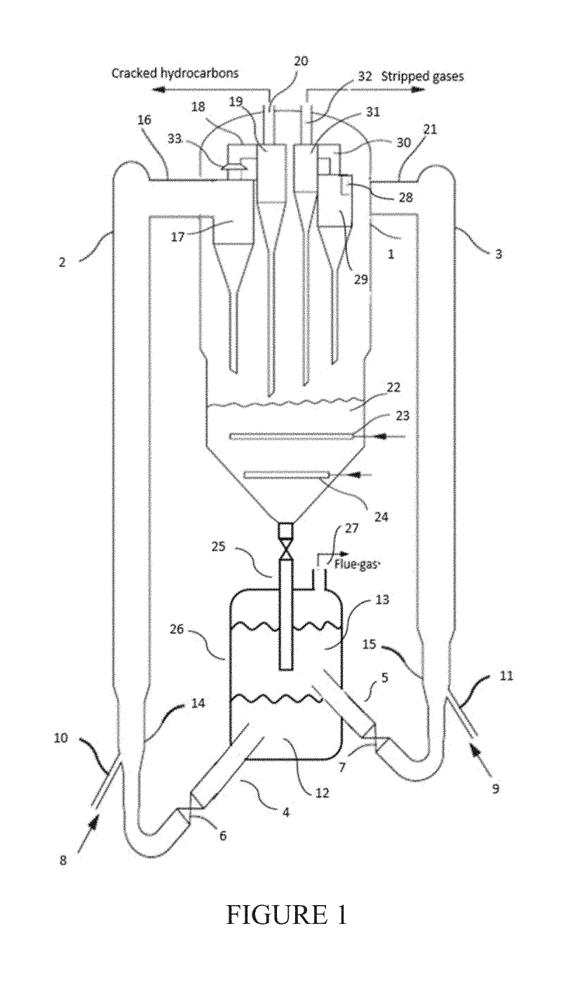

FIG. 1 is simplified outline of a dual external riser FCC unit. The unit comprises a reactor 1 with a first riser 2 and a second riser 3 connected to the foot of the reactor by means of regenerated catalyst standpipes 4 and 5 fitted with slide valves 6 and 7, respectively, to control the flow of catalyst in the normal way. In FIG. 1, first riser 2 is designed to receive a hydrocarbon feed 8, such as a heavy gasoil feed, light gasoil feed, light olefin feed, etc. with any recycle through feed inlet 10 to meet a hot, regenerated first catalyst 12 in mixing zone 14. The mix of cracked products and catalyst passes from the top of first riser 2 through transfer duct 16 into the primary reactor cyclone 17 in which the majority of the spent catalyst is separated from the cracked hydrocarbon vapors which then pass by way of duct 18 to the secondary reactor cyclone 19. For purposes of illustration, FIG. 1 only shows one primary reactor cyclone and one secondary reactor cyclone, however, an external riser reactor will generally have multiple first stage and second stage cyclones in a reactor. Finally, the cracked hydrocarbon vapors leave the reactor cyclones through duct 20 to pass to the main column flash zone.

Second riser 3 is designed to receive an oxygenate feed 9, such as methanol, through feed inlet 11 to meet a hot, regenerated second catalyst 13 in mixing zone 15. The mix of cracked products, mostly olefins, and catalyst passes through the top of riser 3 through transfer duct 21 into a reactor cyclone scheme (not shown) as described above with respect to the heavy oil feed.

The separated catalyst passes down the diplegs of cyclones 17 and 19 directly into a bed of catalyst 22 in the stripper section of the reactor vessel where it is met by a stream of stripping gas from plate sparger 23. The stripping gas leaving the sparger 23 will typically comprise steam. As the stripping gas ascends through the bed of catalyst, which is maintained in a fluidized state by its passage, its composition will change to comprise varying amounts of flue gas components (i.e. CO, CO₂, H₂O, and O₂), as contaminants are stripped from the catalysts. The composition will change with the height of the bed with the proportion of the carbon oxides and water increasing with height in the bed. Steam or nitrogen is admitted through a lower sparger 24 as displacement gas to ensure that the stripping gas passes up through the catalyst rather than passing down the standpipe 25 to the regenerator 26.

Stripped first catalyst 12 and second catalyst 13 are then transported via standpipe 25 to regenerator 26. A combustion reaction to burn off any remaining coke on the catalysts is initiated. The combustion products pass upwards in the regenerator 26 and out duct 27. The descending stream of catalysts is heated by the heat from the combustion reactions taking place lower down in the regenerator 26. Additionally and/or alternatively, because the conversion of methanol to olefins is exothermic, in certain aspects at least a portion of heat from that reaction can be used to aid in regeneration of spent catalyst. Heat can be transferred from second riser 3 to regenerator 26 by any convenient means such as an air duct or heat pipe.

The stripper gases comprising stripped hydrocarbon vapors pass upwards from the stripping bed and leave the reactor vessel by way of inlet 28 to the primary stripper cyclone 29. The gases separated in cyclone 29 then pass through transfer duct 30 to secondary stripper cyclone 31 and finally out of the reactor vessel by way of duct 32 leading to the fuel gas system. The stripper off gases may alternatively or in addition be removed from the reactor by way of vent 33 in the outlet duct of the primary reactor cyclone. Catalyst entrained in the stripper vapors is separated in the stripper cyclones 29 and 31 and then passes down through the diplegs of these cyclones to be returned to the spent catalyst bed 22 underneath. The stripper overhead vapor and riser effluent can utilize the same set of cyclones and only one stream will be leaving as the reaction section product to the main column.

For purposes of illustration, not limitation, the first catalyst can be any catalyst suitable for conventional FCC operations. Such catalysts can include catalysts based on large pore size framework structures 20 (12-member rings) such as the synthetic faujasites, especially zeolite Y, such as in the form of zeolite USY. Zeolite beta may also be used as the zeolite component. Other materials of acidic functionality which may be used in the catalyst include the materials identified as MCM-36 and MCM-49. Still other materials can include other types of molecular sieves having suitable framework structures, such as silicoaluminophosphates (SAPOs), aluminosilicates having other heteroatoms in the framework structure, such as Ga, Sn, or Zn, or silicoaluminophosphates having other heteroatoms in the framework structure. Mordenite or other solid acid catalysts can also be used as the catalyst.

The second catalyst will typically comprise a zeolite catalyst. A suitable zeolite can include a 10-member or 12-member ring pore channel network, such as a 1-dimensional 10-member ring pore channel or a 3-dimensional 10-member ring pore channel. Examples of suitable zeolites having a 3-dimensional 10-member ring pore channel network include zeolites having an MEI or

MEL framework, such as ZSM-5 or ZSM-11. ZSM-5 is described in detail in U.S. Pat. Nos. 3,702,886 and Re. 29,948. ZSM-11 is described in detail in U.S. Pat. No. 3,709,979. Preferably, the zeolite is ZSM-5. Examples of suitable zeolites having a 1-dimensional 10-member ring pore channel network include zeolites having a MRE (ZSM-48), MTW, TON, MTT, and/or MES framework. In some aspects, a zeolite with a 3-dimensional pore channel can be preferred for conversion of methanol, such as a zeolite with an MFI framework.

The first and second catalysts can be the same or different. In some cases, it may be optimal to choose a first catalyst for conventional FCC operations in the first riser 2 and a different second catalyst for MTO conversion in the second riser 3. In such cases, it is necessary to separate the two catalysts from one another in regenerator 26 such that the first catalyst 12 is directed to first riser 2 through standpipe 4 and the second catalyst 13 is directed to second riser 3 through standpipe 5. One option, shown in FIG. 1, is to choose first and second catalysts having differing densities. In this embodiment, the second catalyst 13 is less dense than the first catalyst 12. The two catalysts are permitted to naturally separate from one another based on the density differential and form two layers of catalyst—the first catalyst 12 on the bottom layer and the second catalyst 13 on the top layer. In the embodiment shown, standpipe 5 is positioned such that it draws regenerated catalyst only from the top layer of second catalyst 13. Likewise, standpipe 4 is positioned such that it draws regenerated catalyst only from the bottom layer of first catalyst 12.

It should also be noted that the configuration described above is only one configuration of external riser FCC reactor designs for which the present invention may be utilized. Here, two external risers are shown, but the second riser may also be substituted with a fluidized bed. Alternatively, in place of a second riser or fluidized bed, oxygenate may be injected directly into the dipleg of primary cyclone 17 and/or secondary cyclone 19. Although the FCC catalyst at this point would be theoretically spent for conventional FCC cracking, MTO does not require as much catalyst activity. There is sufficient activity left in the spent FCC catalyst to perform methanol to olefin conversion simply by injecting methanol into a cyclone dipleg.

In yet another alternative embodiment not shown, the reactor vessel may also comprise a baffle that keeps the spent and subsequently regenerated first and second catalysts separated from one other throughout the FCC and MTO processes. Here, the standpipes 4 and 5 may be at equal elevation in the unit as the first and second catalysts will be separated by the baffle.

### Methanol to Olefin Reaction Conditions

As noted above, embodiments of the presently disclosed subject matter include a stage in which a feed comprising an oxygenate, e.g., methanol, dimethyl ether, or a mixture thereof is introduced to an external riser of an FCC unit having a methanol conversion catalyst therein. The riser is controlled to provide conditions suitable for the catalyst to convert at least a portion of the oxygenate to an intermediate composition comprising one or more olefins having 2 or more carbon atoms, sometimes referred to as a light C₂+ olefin composition. This process is known as a MTO (methanol to olefin) reaction.

The temperature of reaction during methanol conversion may be from about ≥ about 250° C., e.g., ≥ about 275° C., ≥ about 300° C., ≥ about 330° C., ≥ about 350° C., ≥ about 375° C., ≥ about 400° C., ≥ about 425° C., to about 450° C., ≥ about 500° C., ≥ about 525° C., ≥ about 550° C., or ≥ about 575° C. Additionally or alternatively, the temperature of reaction during methanol conversion may be ≤ about 760° C., e.g., ≤ about 575° C., ≤ about 550° C., ≤ about 525° C., ≤ about 500° C., ≤ about 450° C., ≤ about 425° C., ≤ about 400° C., ≤ about 375° C., ≤ about 350° C., ≤ about 330° C., ≤ about 300° C., or ≤ about 275° C. Ranges of the temperature of reaction during methanol conversion expressly disclosed include all combinations of any of the above-enumerated values; e.g., about 250° C. to about 760° C., about 275° C. to about 575° C., about 330° C. to about 550° C., about 350° C. to about 525° C., about 375° C. to about 500° C., about 400° C. to about 475° C., about 425° C. to about 450° C., about 400° C. to about 500° C., about 425° C. to about 500° C., about 450° C. to about 500° C., about 475° C. to about 500° C., etc. In a preferred embodiment, the temperature in the MTO riser is about 537° C. to about 700° C., e.g. about 650° C. or about 595° C.

The weight hourly space velocity (WHSV) of feed stock during methanol conversion may be ≥ about 0.1 hr⁻¹, e.g., ≥ about 1.0 hr⁻¹, ≥ about 10 hr⁻¹, ≥ about 50 hr⁻¹, ≥ about 100 hr⁻¹, ≥ about 200 hr⁻¹, ≥ about 300 hr⁻¹, or ≥ about 400 hr⁻¹. Additionally or alternatively, the WHSV may be ≤ about 500 hr⁻¹, e.g., ≤ about 400 hr⁻¹, ≤ about 300 hr⁻¹, ≤about 200 hr⁻¹, ≤ about 100 hr⁻¹, ≤ about 50 hr⁻¹, ≤ about 10 hr⁻¹, or ≤ about 1.0 hr⁻¹. Ranges of the WHSV expressly disclosed include all combinations of any of the above-enumerated values; e.g., from about 0.1 hr⁻¹ to about 500 hr⁻¹, from about 0.5 hr ⁻¹, to about 100 hr⁻¹, from about 1.0 hr⁻¹ to about 10 hr⁻¹, from about 2.0 hr⁻¹ to about 5.0 hr⁻¹, etc. In a preferred embodiment, the WHSV in the MTO riser is about 1-150 h⁻¹, e.g. about 10-100 h⁻¹ or about 20-85 h⁻¹.

In any embodiment, combinations of the above described ranges of the WHSV, temperature and pressures may be employed for the methanol conversion. For example in some embodiments, the temperature of the reaction vessel during methanol conversion may be from about 500° C. to about 760° C., e.g., about 525° C. to about 650° C., about 550° C. to about 600° C., about 575° C. to about 600° C., or at about 585° C.; the WHSV may be about 1 hr⁻¹ to about 100 hr⁻¹, e.g., about 5 hr⁻¹ to about 85 hr⁻¹, about 15 hr⁻¹ to about 60 hr⁻¹, about 1.0 hr⁻¹ to about 4.0 hr⁻¹, or about 2.0 hr⁻¹ to about 3.0 hr⁻¹; and/or the pressure may be about 50 psig to about 200 psig, e.g., about 75 psig to about 150 psig or about 75 psig to about 100 psig. All combinations and permutations of these values are expressly disclosed. For example, in particular embodiments, the temperature may be about 475° C. to about 500° C., the WHSV may be about 1.0 hr⁻¹ to about 4.0 hr⁻¹, and the pressure may be 75 psig to about 100 psig.

The methanol conversion catalyst may be selected from aluminosilicate zeolites and silicoaluminophosphate zeotype materials. Typically, such materials useful herein have a microporous surface area ≥150 m²/g, e.g., ≥155 m²/g, 160 m²/g, 165 m²/g, ≥200 m²/g, ≥250 m²/g, ≥300 m²/g, ≥350 m²/g, ≥400 m²/g, ≥450 m²/g, ≥500 m²/g, ≥550 m²/g, ≥600 m²/g, ≥650 m²/g, ≥700 m²/g, ≥750 m²/g, ≥800 m²/g, ≥850 m²/g, ≥900 m²/g, ≥950 m²/g, or ≥1000 m²/g. Additionally or alternatively, the surface area may be ≤1200 m²/g, e.g., ≤1000 m²/g, <950 m²/g, ≤900 m²/g, ≤850 m²/g, ≤800 m²/g, ≤750 m²/g, ≤700 m²/g, ≤650 m²/g, ≤600 m²/g, ≥550 m²/g, ≤500 m²/g, ≤450 m²/g, ≤400 m²/g, ≤350 m²/g, ≤250 m^{2/g, ≤}200 m²/g, ≤165 m²/g, ≤160 m²/g, or ≤155 m²/g. Ranges of the surface area expressly disclosed include all combinations of any of the above-enumerated values; e.g., 150 m²/g to 1200 m²/g, 160 m²/g to about 1000 m²/g, 165 m²/g to 950 m²/g, 200 m²/g to 900 m²/g, 250 m²/g to 850 m²/g, 300 m²/g to 800 m²/g, 275 m²/g to 750 m²/g, 300 m²/g to 700 m²/g, 350 m²/g to 650 m²/g, 400 m²/g to 600 m²/g, 450 m²/g to 550 m²/g, etc.

The methanol conversion catalyst may have any ratio of silicon to aluminum. Particular catalysts have a molar ratio of silicon to aluminum ≥about 10, e.g., ≥ about 20, ≥ about 30, ≥ about 40, ≥ about 42, ≥ about 45, ≥ about 48, ≥ about 50, ≥ about 60, ≥ about 70, ≥ about 80, ≥ about 90, ≥ about 100, ≥ about 120, ≥ about 140, ≥ about 180, or ≥ about 200. Additionally or alternatively, the methanol conversion catalyst may have a molar ratio of silicon to aluminum ≤ about 200, e.g., ≤ about 180, ≤ about 140, ≤ about 120, ≤ about 100, ≤ about 90, ≤ about 80, ≤ about 70, ≤ about 60, ≤ about 50, ≤ about 48, ≤ about 45, ≤ about 42, ≤ about 40, ≤ about 30, or ≤ about 20. Ranges of the molar ratio expressly disclosed include all combinations of any of the above-enumerated values; e.g., about 10 to about 200, about 20 to about 180, about 30 to about 140, about 40 to about 120, about 40 to about 100, about 45 to about 90, about 30 to about 50, about 42 to about 48, etc. The silicon: aluminum ratio may be selected or adjusted to provide a desired activity and/or a desired distribution of molecules from the methanol conversion.

Additionally or alternatively, particular aluminosilicate zeolites useful as methanol conversion catalysts have a hexane cracking activity (also referred to as “alpha-activity” or as “alpha value”) ≥ about 5, e.g., ≥ about 10, ≥ about 20, ≥ about 40, ≥ about 60, ≥ about 80, ≥ about 100, ≥ about 160, or ≥ about 180. Additionally or alternatively, the hexane cracking activity of the methanol conversion catalyst may be ≤ about 200, e.g., ≤ about 180, ≤ about 160, ≤ about 140, ≤ about 120, ≤ about 100, ≤ about 80, ≤ about 60, ≤ about 40. Ranges of the alpha values expressly disclosed include all combinations of any of the above-enumerated values; e.g., ˜50 to ˜200, ˜10 to ˜180, ˜20 to ˜160, ˜40 to ˜140, ˜60 to ˜120, etc. Hexane cracking activity according to the alpha test is described in U.S. Pat. No. 3,354,078; in the Journal of Catalysis at vol. 4, p. 527 (1965), vol. 6, p. 278 (1966), and vol. 61, p. 395 (1980), each incorporated herein by reference as to that description. The experimental conditions of the test used herein include a constant temperature of about 538° C. and a variable flow rate as described in detail in the Journal of Catalysis at vol. 61, p. 395. Higher alpha values typically correspond to a more active cracking catalyst. In a preferred embodiment, the alpha activity, α, is 5-130, e.g. 10, 25, 75, or 130.

Aluminosilicate zeolites useful as methanol conversion catalyst may be characterized by an International Zeolite Associate (IZA) Structure Commission framework type selected from the group consisting of BEA, CHA, EUO, FER, IMF, LAU, MEL, MFI, MRE, MFS, MTT, MWW, NES, TON, SFG, STF, STI, TUN, PUN, and combinations and intergrowths thereof

Particular examples of suitable methanol conversion catalysts can include ZSM-5, ZSM-11, ZSM-12, ZSM-22, ZSM-23, ZSM-35, and ZSM-48 as well as combinations thereof. Particularly useful catalysts can include zeolites having an MRE-type IZA framework, e.g., Z SM-48 catalyst, particularly where improved conversion to distillate is desired. Other particularly useful catalysts may include zeolites having an MFI-type IZA framework, e.g., H-ZSM-5 catalyst, particularly for distillate feeds, provided the catalyst has been steamed as is known in the art. In some embodiments, the catalyst may include or be ZSM-12. Catalyst activity may be modified, e.g., by use of catalysts that are not fully exchanged. Activity is also known to be affected by the silicon: aluminum ratio of the catalyst. For example, catalysts prepared to have a higher silica: aluminum ratio can tend to have lower activity. The person of ordinary skill will recognize that the activity can be modified to give the desired low aromatic product in methanol conversion.

Zeolite ZSM-5 and the conventional preparation thereof are described in U.S. Pat. No. 3,702,886. Zeolite ZSM-11 and the conventional preparation thereof are described in U.S. Pat. No. 3,709,979. Zeolite ZSM-12 and the conventional preparation thereof are described in U.S. Pat. No. 3,832,449. Zeolite ZSM-23 and the conventional preparation thereof are described U.S. Pat. No. 4,076,842. Zeolite ZSM-35 and the conventional preparation thereof are described in U.S. Pat. No. 4,016,245. ZSM-48 and the conventional preparation thereof are taught by U.S. Pat. No. 4,375,573. The entire disclosures of these U.S. patents are incorporated herein by reference.

Exemplary silicoaluminophosphates that may be useful herein can include one or a combination of SAPO-5, SAPO-8, SAPO-11, SAPO-16, SAPO-17, SAPO-18, SAPO-20, SAPO-31, SAPO-34, SAPO-35, SAPO-36, SAPO-37, SAPO-40, SAPO-41, SAPO-42, SAPO-44, SAPO-47, and SAPO-56.

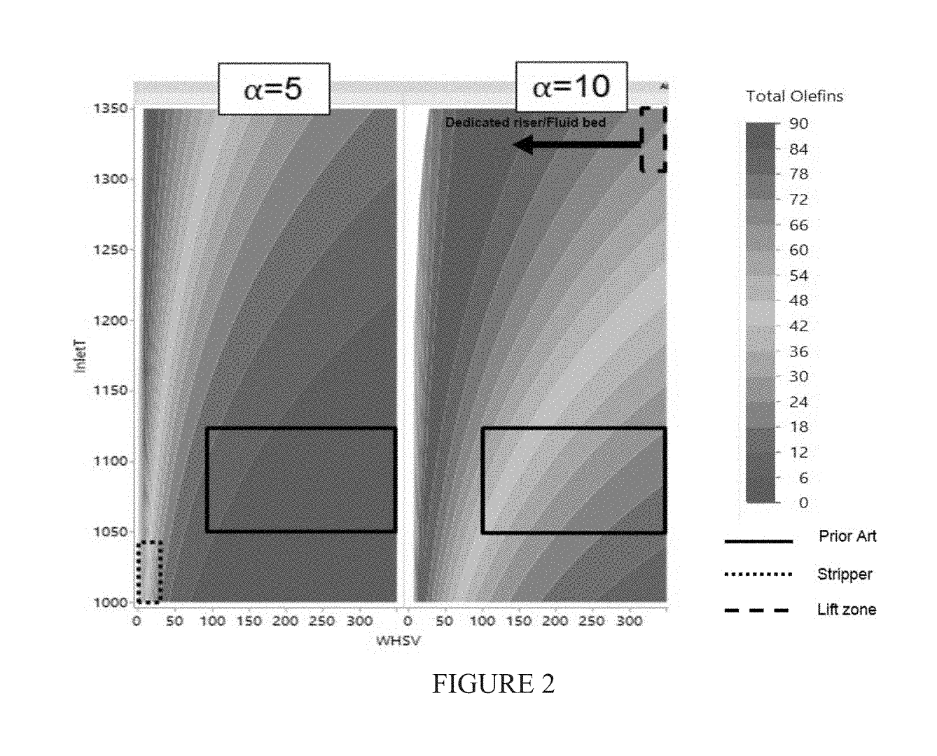

FIG. 2 provides a model-based prediction of potential methanol to olefin conversion prediction using a second dedicated riser in a FCC unit. Olefin yield predictions were generated based on a detailed kinetic model that discretely tracks >100 individual species. The model was originally developed and tuned with large and detailed data sets to support methanol to gasoline catalyst and process development, of which the relevant reactions here are a subset. For the sake of simplicity here, the model utilized isothermal conditions and assumed plug flow of catalyst and feed which was simulated as a fixed-bed. The large “Prior Art” box depicts the conversion rate hypothesized to be disclosed in the Pan et al. reference discussed above. This is based on the temperature ranges and olefin production disclosed in the reference. The small dashed box in FIG. 2 predicts MTO conversion if methanol was added to the stripper section of an existing FCC unit. The large dashed box in FIG. 2 predicts the MTO conversion if methanol was simply introduced with the heavy oil feed to the lift zone of a single riser FCC unit. As shown, the addition of a dedicated MTO riser in an existing FCC unit allows the user to optimize parameters, (alpha-activity, temperature, and WHSV shown) to maximize MTO conversion. Table 1 below shows a comparison of predicted olefin yields between using a single riser at conventional FCC conditions and a dedicated MTO riser on the FCC unit so that MTO conversion can be maximized.

Predicted Olefin Yields (wt. %)

| | Single Riser | Dedicated MTO Riser |
|---|---|---|
| Temperature | (α = 10, | (α = 10, |
| (° C.) | WHSV = 350 h⁻¹) | WHSV as listed) |
| 538 | 8 | 83 @ 14.5 h⁻¹ |
| 593 | 21 | 86 @ 28.5 h⁻¹ |
| 649 | 40 | 87 @ 56.5 h⁻¹ |
| 704 | 59 | 89 @ 84.5 h⁻¹ |

As shown, the ability to tailor the dedicated MTO riser conditions allows for greater methanol to olefin yield at different temperatures, activities, and space velocities.

### Additional or Alternative Embodiments

Embodiment 1. A dual riser fluid catalytic cracking process, comprising: cracking a hydrocarbon feed in a first riser comprising a first catalyst under first riser conditions to form a first effluent enriched in olefins, light gasoil, gasoline, or a combination thereof; cracking a hydrocarbon oxygenate feed in a second riser comprising a second catalyst under second riser conditions to form a second effluent enriched in olefins; recovering the first and second catalyst from the first and second effluents in a common reactor; regenerating the recovered first and second catalyst in a regenerator using heat from the exothermic cracking of the hydrocarbon oxygenate feed; and recirculating the regenerated first and second catalyst to the first and second riser.

Embodiment 2. The process of embodiment 1, wherein the hydrocarbon oxygenate feed includes methanol.

Embodiment 3. The process of any of the previous embodiments, wherein the second riser conditions include a catalyst activity, α, of about 5 to 130.

Embodiment 4. The process of any of the previous embodiments, wherein the catalyst activity, α, is about 10.

Embodiment 5. The process of any of the previous embodiments, wherein the second riser conditions include a weight hourly space velocity (WHSV) of about 1-150 hr⁻¹.

Embodiment 6. The process of any of the previous embodiments, wherein the weight hourly space velocity (WHSV) is about 10-100 hr ⁻¹.

Embodiment 7. The process of any of the previous embodiments, wherein the weight hourly space velocity (WHSV) is about 20-85 hr⁻¹.

Embodiment 8. The process of any of the previous embodiments, wherein the second riser conditions include a temperature of 538-760° C. and a weigh hourly space velocity (WHSV) of about 20-85 hr⁻¹.

Embodiment 9. The process of any of the previous embodiments, wherein the first catalyst and the second catalyst are different.

Embodiment 10. The process of any of the previous embodiments, wherein the first catalyst is a USY catalyst and the second catalyst is ZSM-5, ZSM-11, ZSM-48, or a combination thereof.

Embodiment 11. The process of any of the previous embodiments, wherein the first catalyst and the second catalysts are different densities such that they form a layer of first catalyst and a layer of second catalyst in the regenerator; wherein recirculating the regenerated first and second catalyst to the first and second riser further comprises positioning a first riser standpipe to recirculate regenerated first catalyst to the first riser from the layer of first catalyst; and positioning a second riser standpipe to recirculate a regenerated second catalyst to the second riser from the layer of second catalyst.

Embodiment 12. The process of any of embodiments 1-10, wherein the first and second catalysts kept separate from one another by a baffle within the common reactor.

All documents described herein are incorporated by reference herein for purposes of all jurisdictions where such practice is allowed, including any priority documents and/or testing procedures to the extent they are not inconsistent with this text, provided however that any priority document not named in the initially filed application or filing documents is NOT incorporated by reference herein. As is apparent from the foregoing general description and the specific aspects, while forms of the invention have been illustrated and described, various modifications can be made without departing from the spirit and scope of the invention. Accordingly, it is not intended that the invention be limited thereby. Likewise, the term “comprising” is considered synonymous with the term “including.” Likewise whenever a composition, an element or a group of elements is preceded with the transitional phrase “comprising,” it is understood that we also contemplate the same composition or group of elements with transitional phrases “consisting essentially of,” “consisting of,” “selected from the group of consisting of,” or “is” preceding the recitation of the composition, element, or elements and vice versa. Aspects of the invention include those that are substantially free of or essentially free of any element, step, composition, ingredient or other claim element not expressly recited or described.

1. A dual riser fluid catalytic cracking process, comprising:
cracking a hydrocarbon feed in a first riser comprising a first catalyst under first riser conditions to form a first effluent enriched in olefins, light gasoil, gasoline, or a combination thereof;
cracking a hydrocarbon oxygenate feed in a second riser comprising a second catalyst under second riser conditions to form a second effluent enriched in olefins;
recovering the first and second catalyst from the first and second effluents in a common reactor;
regenerating the recovered first and second catalyst in a regenerator using heat from the exothermic cracking of the hydrocarbon oxygenate feed; and
recirculating the regenerated first and second catalyst to the first and second riser.

2. The process of claim 1, wherein the hydrocarbon oxygenate feed includes methanol.

3. The process of claim 1, wherein the second riser conditions include a catalyst activity, α, of about 5 to 130.

4. The process of claim 3, wherein the catalyst activity, α, is about 10.

5. The process of claim 1, wherein the second riser conditions include a weight hourly space velocity (WHSV) of about 1-150 h⁻¹.

6. The process of claim 5, wherein the weight hourly space velocity (WHSV) is about 10-100 h⁻¹.

7. The process of claim 6, wherein the weight hourly space velocity (WHSV) is about 20-85 h⁻¹.

8. The process of claim 1, wherein the second riser conditions include a temperature of 538-760° C. and a weigh hourly space velocity (WHSV) of about 20-85 h⁻¹.

9. The process of claim 1, wherein the first catalyst and the second catalyst are different.

10. The process of claim 9, wherein the first catalyst is a USY catalyst and the second catalyst is ZSM-5, ZSM-11, ZSM-48, or a combination thereof.

11. The process of claim 9, wherein the first catalyst and the second catalysts are different densities such that they form a layer of first catalyst and a layer of second catalyst in the regenerator; wherein recirculating the regenerated first and second catalyst to the first and second riser further comprises
positioning a first riser standpipe to recirculate regenerated first catalyst to the first riser from the layer of first catalyst; and
positioning a second riser standpipe to recirculate a regenerated second catalyst to the second riser from the layer of second catalyst.

12. The process of claim 9, wherein the first and second catalysts kept separate from one another by a baffle within the common reactor.
